(19) United States
(12) Patent Application Publication
(10) Pub. No.: US 2008/0131345 A1
(43) Pub. Date: Jun. 5, 2008

(54) Multi-bed selective catalytic reduction system and method for reducing nitrogen oxides emissions

(76) Inventors: Frederic Vitse, Schenectady, NY (US); Dan Hancu, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/606,432

(22) Filed: Nov. 30, 2006

(51) Int. Cl. B01D 53/56

(52) U.S. Cl. 423/239.1; 422/177; 422/171

(57) ABSTRACT

Systems and methods of removing at least nitrogen oxides from an exhaust fluid generally include introducing a first reducing agent and a hydrogen gas co-reductant agent into the exhaust fluid upstream of a catalyst bed optimized for a hydrocarbon selective catalytic reduction process to reduce nitrogen oxides present in the exhaust fluid and then reacting residual nitrogen oxides in a second catalytic bed optimized for an ammonia selective catalytic reduction process. The use of hydrogen gas permits efficient reduction of nitrogen oxides over a wide temperature range, which is minimally affected by the presence of sulfur dioxide in the exhaust fluid.

### BACKGROUND

The present disclosure generally relates to systems and methods for reducing nitrogen oxides (NO_{X}) emissions, and more particularly, to systems and methods that employ selective catalytic reduction.

An internal combustion engine, for example, transforms fuel such as gasoline, diesel, and the like, into work or motive power through combustion reactions. These reactions produce byproducts such as carbon monoxide (CO), unburned hydrocarbons (UHC), and nitrogen oxides (NO_{X}) (e.g., nitric oxide (NO) and nitrogen dioxide (NO₂)). Air pollution concerns worldwide have led to stricter emissions standards for engine systems. As such, research is continually being conducted into systems and methods for reducing at least the nitrogen oxides emissions.

One method of removing nitrogen oxides from an exhaust fluid involves a selective catalytic reduction (SCR) process in which nitrogen oxides are reduced. For example, an ammonia-SCR process is widely used, wherein ammonia is used as a reducing agent in the selective catalytic reduction process to produce nitrogen gas and water. Ammonia-SCR, also referred to as NH₃—SCR, is commonly used because of its catalytic reactivity and selectivity. However, practical use of ammonia has been largely limited to power plants and other stationary applications. More specifically, the toxicity and handling problems (e.g., storage tanks) associated with ammonia has made use of the technology in automobiles and other mobile engines impractical. For example, current regulations with regard to ammonia slip in vehicle exhaust systems are oftentimes difficult to meet.

The selective catalytic reduction of nitrogen oxides with hydrocarbons (HC—SCR) has also been exhaustively studied in recent years as a potential competitor to the NH₃—SCR process. The hydrocarbon reductant reacts with the nitrogen oxides in the exhaust stream to form primarily nitrogen gas and carbon dioxide. The main advantage of this selective catalytic reduction process is the use of hydrocarbons as the reducing species as opposed to ammonia, which has minimal concerns with regard to slippage. The catalysts used in the HC—SCR process can generally be divided into three main groups: (a) supported noble metals; (b) zeolites exchanged with metal ions; and (c) metal oxide catalysts. These materials have demonstrated catalytic behavior at reaction temperatures as low as 120-250° C. However, these catalysts generally present a narrow operating temperature range and deactivate relatively quickly in the presence of SO₂. As such, these types of beds are impractical in processing exhaust fluid streams generated from fuels containing appreciable levels of sulfur dioxide and/or transient applications where the catalyst material is subjected to a broad range of temperatures.

Accordingly, a continual need exists for improved systems and methods for reducing nitrogen oxide emissions.

### BRIEF SUMMARY

Disclosed herein are systems and methods for removing nitrogen oxides emissions. In one embodiment, the method of removing at least nitrogen oxides from an exhaust fluid comprises, in sequence, providing an exhaust fluid comprising a concentration of nitrogen oxides; introducing a first reducing agent and a hydrogen gas to the exhaust fluid upstream of a first catalytic bed optimized for hydrocarbon selective catalytic reduction in fluid communication therewith to reduce the concentration of nitrogen oxides in the exhaust fluid, wherein the first reducing agent comprises a hydrocarbon, an alcohol, or a combination comprising at least one of the foregoing; and further reducing the concentration of nitrogen oxides in a second catalytic bed optimized for ammonia selective catalytic reduction, wherein further reducing the concentration of nitrogen oxides comprises injecting a nitrogen hydride, an ammonia precursor, or a combination thereof into the second catalytic bed.

A system of removing at least nitrogen oxides from an exhaust gas comprises an exhaust conduit comprising a first catalytic bed optimized for a hydrocarbon selective catalytic reduction process fluidly coupled to a second catalytic bed disposed downstream from the first catalytic bed and optimized for an ammonia selective catalytic reduction process; and a first reductant fluid source and a hydrogen gas co-reductant source in fluid communication with the exhaust conduit and adapted to be introduced into an exhaust fluid upstream from the first catalytic bed; wherein the first reductant source is selected from the group consisting of a hydrocarbon, an alcohol, or a combination comprising at least one of the foregoing

The above described and other features are exemplified by the following Figures and detailed description.

### BRIEF DESCRIPTION OF THE DRAWINGS

Referring to the exemplary drawings wherein like elements are numbered alike in the several Figures:

FIG. 1 is a schematic illustration of an embodiment of a system for reducing at least nitrogen oxides emissions; and

FIG. 2 is a schematic illustration of another embodiment of a system for reducing at least nitrogen oxides emissions.

### DETAILED DESCRIPTION

Disclosed herein are systems and methods for reducing the emission of nitrogen oxides. As will be discussed in greater detail, the systems and methods generally employ a multi-bed selective catalytic reduction system to reduce at least the nitrogen oxides in an exhaust gas stream. The multi-bed selective catalytic reduction system generally includes a bed optimized for hydrocarbon selective catalyst reduction (HC—SCR) that is fluidly coupled to a second bed optimized for ammonia selective catalytic reduction (NH₃—SCR), wherein a first reductant and a co-reductant are co-injected prior the exhaust gas stream entering the HC—SCR. It has advantageously been discovered that the use of hydrogen gas as a co-reductant permits the use of the HC—SCR bed in the presence of sulfur dioxide containing exhaust gases without sacrificing the operable temperature range. For example, Applicants have discovered that the multi-bed system disclosed herein is effective for NOx reductions at temperatures from about 150° C. to about 600° C., even in the presence of sulfur dioxide. Moreover, the multi-bed system can be used to efficiently reduce nitrogen oxides to nitrogen in sulfur dioxide containing exhaust gases. Still further, the use of hydrogen gas in the HC—SCR optimized bed permits lower levels of hydrocarbon to be used for efficient catalytic reduction of the nitrogen oxides. By using the multi-bed in this manner, ammonia slippage is substantially prevented since lower amounts are used in view of the effectiveness of the HC—SCR optimized bed.

In the following description, an “upstream” direction refers to the direction from which the local flow is coming, while a “downstream” direction refers to the direction in which the local flow is traveling. In the most general sense, flow through the system tends to be from front to back, so the “upstream direction” will generally refer to a forward direction, while a “downstream direction” will refer to a rearward direction. The terms reducing agent and reductant are used interchangeably throughout this disclosure.

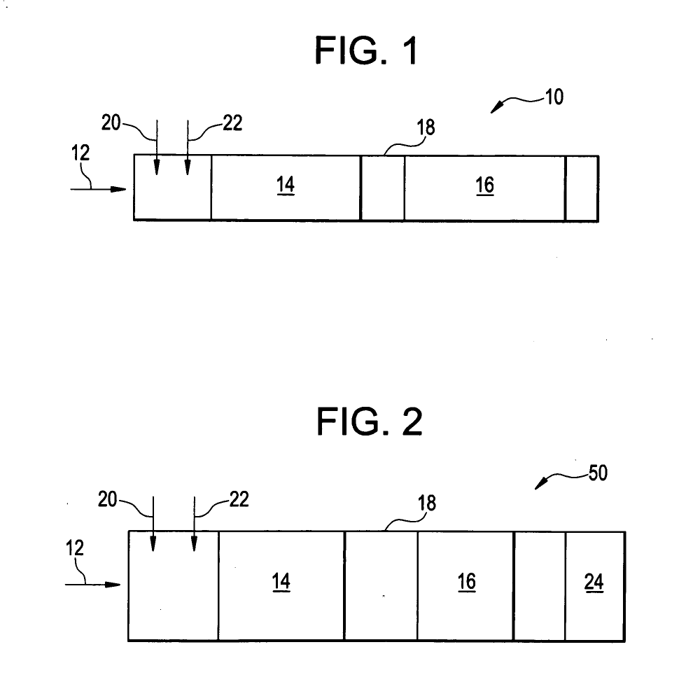

Referring to FIG. 1, a multi-bed system 10 for reducing at least nitrogen oxides emissions is illustrated. Advantageously, the system 10 can be employed in both stationary applications as well as mobile applications such as vehicle systems (e.g., locomotives, trucks, and the like). The system 10 comprises an exhaust fluid source 12 in fluid communication with an exhaust conduit 18. Disposed within the exhaust conduit 18 are a first selective catalytic reduction bed 14 and a second selective catalytic reduction bed 16, wherein the first bed 14 is disposed upstream relative the second bed 16. In addition, the system 10 includes a first reductant source 20, and a co-reductant hydrogen gas source 22 in fluid communication with the exhaust conduit and at a location upstream from the first selective catalytic reduction bed 14.

The exhaust fluid source 12 includes any source of an exhaust fluid that comprises nitrogen oxides (NO_{X}). In addition, the multi-bed system 10 with the co-reductant hydrogen gas is suitable for use with exhaust fluid streams that further include sulfur-containing compounds such as sulfur dioxide (SO₂). By way of example, the exhaust fluid source 12 can include, but is not limited to, exhaust fluids from spark ignition engines and compression ignition engines. While spark ignition engines are commonly referred to as gasoline engines and compression ignition engines are commonly referred to as diesel engines, it is to be understood that various other types of fuels can be employed in the respective internal combustion engines. Examples of the fuels include hydrocarbon fuels such as gasoline, diesel, ethanol, methanol, kerosene, and the like; gaseous fuels, such as natural gas, propane, butane, and the like; and alternative fuels, such as hydrogen, biofuels, dimethyl ether, and the like; as well as combinations comprising at least one of the foregoing fuels.

As shown, the exhaust fluid source 12 is disposed upstream of and in fluid communication with the first selective catalytic reduction (SCR) bed 14. The first SCR bed 14 comprises a selective catalyst reduction bed optimized for a HC—SCR process, (hereinafter referred to as the HC—SCR bed). The HC—SCR bed generally includes a first active catalyst material and a second active catalyst material, wherein the first active catalyst material generally comprises silver metal or its oxide, and the second active catalyst material is selected such that its sulfide is active toward NO_{X} selective catalytic reduction. Suitable second catalyst materials include, but are not limited to, gallium (Ga), indium (In), tin (Sn), gold (Au), cobalt (Co), nickel (Ni), zinc (Zn), copper (Cu), platinum (Pt), and palladium (Pd), as well as oxides and alloys comprising at least one of the foregoing. The catalyst is typically placed at a location within the exhaust conduit where it will be exposed to exhaust gas containing the NOₓ. The catalyst may be arranged as a packed or fluidized bed reactor, coated on a monolithic or membrane structure, or arranged in any other manner within the exhaust system such that the catalyst is in contact with the effluent gas. In one embodiment, the HC—SCR bed 14 comprises a combination of silver and gallium.

In addition to the first and second active catalyst materials, the HC—SCR bed 14 may comprise a substrate and an optional support material, which is sometimes referred as a washcoat layer. The first and second active catalyst material can be disposed directly on a surface of the substrate and/or can be disposed on the optional support material, which in turn can be disposed on a surface of the substrate. The first and the second active catalyst material, as well as the optional support material, can be disposed on the substrate by any suitable method known in the art (e.g., a wash-coating method).

The substrate of the HC—SCR bed 14 is selected to be compatible with the operating environment (e.g., exhaust gas temperatures). Suitable substrate materials include, but are not limited to, cordierite, nitrides, carbides, borides, and intermetallics, mullite, alumina, zeolites, lithium aluminosilicate, titania, feldspars, quartz, fused or amorphous silica, clays, aluminates, titanates such as aluminum titanate, silicates, zirconia, spinels, as well as combinations comprising at least one of the foregoing materials.

The optional support material is selected to be compatible with the operating environment and the active catalyst materials. Suitable support materials include, but are not limited to, inorganic oxides. Exemplary inorganic oxides include, but are not limited to, alumina (Al₂O₃), silica (SiO₂), zirconia (ZrO₂), titania (TiO₂), and combinations comprising at least one of the foregoing.

The first reductant source 20 is in fluid communication with the HC—SCR bed 14 such that during operation a first reducing agent can be introduced upstream of the HC—SCR bed 14. While the choice of the first reducing agent varies depending on the material employed in the HC—SCR bed 14, suitable first reducing agents include, but are not limited to, hydrocarbons, alcohols, and combinations comprising at least one of the foregoing. Exemplary alcohols include, but are not limited to, methanol, ethanol, n-butyl alcohol, 2-butanol, tertiary butyl alcohol, n-propyl alcohol, isopropyl alcohol, and combinations comprising at least one of the foregoing. Exemplary hydrocarbons are not intended to be limited. Suitable hydrocarbons include, among others, olefins such as ethylene, and paraffins such as propane. Preferably, the hydrocarbons are aliphatic hydrocarbons having two to five carbons. Aromatic hydrocarbon, although suitable for some applications, are less preferred because the catalyst generally has low activity for oxidizing hydrocarbons. Aliphatic hydrocarbons with about six or more carbons are not preferable either because they can hardly reach active sites deep in the micropores in the zeolite. Also. it is difficult to obtain sufficient NOx conversion using methane due to its poor reactivity below 400° C.

The co-reductant 22 (i.e., hydrogen gas) is also disposed in fluid communication with the HC—SCR bed 14 such that during operation the co-reductant is introduced upstream along with the first reducing agent. Advantageously, the use of the hydrogen gas in this manner allows the HC—SCR bed 14 to operate over a wider temperature range when compared to systems where hydrogen is not employed as a co-reductant. Moreover, the use of hydrogen gas as a co-reductant permits the use of lower amounts of the hydrocarbon reductant, i.e., the first reductant 20.

In various embodiments, depending on whether the system is for mobile or stationary applications, the reductant and co-reductant can be produced on-board from available fuel or in the case of diesel engines are readily available. In one embodiment, hydrogen gas is advantageously produced on board the system 10 by catalytically converting a fuel, such as those discussed above in relation to the internal combustion engine, into smaller molecules, namely hydrogen and carbon monoxide. In operation, the fuel can be converted to a gas comprising hydrogen using steam reforming, auto-thermal reforming, partial-oxidation, or other known processes.

One advantage of embodiments of the present disclosure is that the reduction reaction in the HC—SCR bed may take place in “lean” conditions. That is, the amount of reductant added to the exhaust gas to reduce the NOₓ is generally low. The molar ratio of reductant to NOₓ is typically from about 0.25:1 to about 3:1. More specifically, the ratio is typically such that the ratio of carbon atoms in the reductant is about 1 to about 24 moles per one mole of NOₓ. Reducing the amount of reductant to convert the NOₓ to nitrogen may provide for a more efficient process that has decreased raw material costs. The reduction reaction may take place over a range of temperatures. Typically, the temperature may range from about 300 to about 600° C., more typically about 350 to about 450° C.

The NH₃—SCR bed 16 is disposed downstream of and in fluid communication with the HC—SCR bed 14 via the exhaust conduit 18. By use of the term “ammonia or NH₃”, it is meant to include nitrogenous compounds such as nitrogen hydrides, e.g. ammonia or hydrazine, or an ammonia precursor. The ammonia can be in anhydrous form or as an aqueous solution, for example. By “ammonia precursors” we mean one or more compounds from which ammonia can be derived, e.g. by hydrolysis. These include urea (CO(NH₂)₂) as an aqueous solution or as a solid or ammonium carbamate (NH₂COONH₄).

The catalysts employed in the second SCR bed 16 vary depending, for example, on the exhaust temperatures of the exhaust fluid as well as the choice of ammonia reducing agents employed in the system 10. By way of example, in the case of a bed containing a vanadium catalyst material, a lower content of the vanadium catalyst may be preferred in some embodiments since as the temperature of the exhaust fluid stream increases, the oxidation of by products in the exhaust stream back to NOx is enhanced.

Suitable active catalyst materials for the NH₃—SCR bed 16 include, but are not limited to, indium (In), copper (Cu), silver (Ag), zinc (Zn), cadmium (Cd), cobalt (Co), nickel (Ni), iron (Fe), molybdenum (Mo), tungsten (W), titanium (Ti), vanadium (V), and zirconium (Zr), as well as oxides and alloys comprising at least one of the foregoing. The NH₃—SCR bed 16 may include a substrate, and an optional support material onto which the catalyst materials are deposited.

The substrate materials suitable for use in the NH₃—SCR bed include, but are not limited to, those materials discussed above in relation to the first SCR bed 14. Suitable materials for the optional support material include, but are not limited, to those materials discussed above in relation the HC—SCR bed 14. In one embodiment, the support material comprises a zeolite. Suitable zeolites include, but are not limited to, mordenites, pentasil structure zeolites such as ZSM type zeolites, in particular ZSM-5 zeolites, and faujasites (Y-type family).

Referring now to FIG. 2, a multi-bed system 50 for reducing nitrogen oxides emissions in accordance with another embodiment is illustrated. As before, the multi-bed system can advantageously be used over a wide range of temperatures as well as in the presence of a sulfur containing material such as SO₂. The system 50 comprises the exhaust gas source 12 in fluid communication with the exhaust conduit 18. The HC—SCR bed 14, and the second SCR bed 16, e.g., the NH₃—SCR bed, are disposed within the exhaust conduit 18. Similar to system 10, the first reductant source 20, and the co-reductant source 22, are disposed upstream from the HC—SCR and are in fluid communication with the exhaust fluid stream. The system 50 further includes a deep oxidation catalyst 24 downstream of and in fluid communication with the second SCR bed 16.

The deep oxidation catalyst 24 is configured to at least enable oxidation of carbon monoxide to carbon dioxide. The deep oxidation catalyst 24 is inclusive of an active catalytic material, a substrate material, and an optional support material. The substrate material is selected to be compatible with the operating environment (e.g., exhaust gas temperatures). Suitable substrate materials include, but are not limited to, those materials discussed above in relation to the first and or second SCR beds. Suitable active catalytic material/support materials include, but are not limited, to noble metal and metal oxides. Exemplary noble metals include combinations of rhodium (Rh) and platinum (Pt). Exemplary metal oxides include, but are not limited to, aluminum oxide (Al₂O₃), zinc oxide (ZnO), and titanium oxide (TiO₂).

In operation of either system 10 or 50, exhaust fluid from the exhaust fluid source 12 travels through the exhaust conduit 18. The first reducing agent and the co-reductant (hydrogen gas) are introduced into the exhaust conduit 18 upstream of the HC—SCR bed 14 such that the reducing agents mix with the exhaust fluid from the exhaust source 12. In the HC—SCR bed 14, the nitrogen oxides present in the exhaust gas react with the first reducing agent and the co-reducing agent such that the nitrogen oxides are substantially reduced to nitrogen gas (N₂). Advantageously, the used of the hydrogen gas in this manner allows the HC—SCR bed 14 to operate over a wider temperature range when compared to systems where hydrogen is not employed as a co-reductant. For example, the HC—SCR bed 14 in accordance with the present disclosure is effective and active over a temperature range of about 150° C. to about 600° C. Moreover, the use of the hydrogen gas advantageously minimizes the effect of sulfur dioxide deactivation of the catalyst materials of at least the HC—SCR bed 14.

The NH₃—SCR bed 16 converts any nitrogen oxides that were not reduced in the HC—SCR bed. The use of the multi-bed 14, 16 in conjunction with hydrogen gas as a co-reductant advantageously allows for greater than or equal to about 75% conversion of NO_{X} to nitrogen gas, specifically greater than or equal to 85% conversion. Embodiments are also envisioned where 100% NO_{X} is converted to nitrogen gas. In system 50 where a deep oxidation catalyst bed 24 is employed, the carbon monoxide contained in the exhaust stream is further oxidized to carbon dioxide.

Advantageously, the systems disclosed herein use hydrogen gas as a co-reductant, which minimizes the effect of sulfur dioxide deactivation of the catalyst materials allowing the use of HC—SCR beds, which can be operated over a wider temperature range. Moreover, the use of multi-bed systems as disclosed herein allows for improved conversion of nitrogen oxides compared to using a single bed. Still further, ammonia slippage is minimized and/or prevented in the multi-bed system since significantly smaller volumes of ammonia are needed.

The following examples are presented for illustrative purposes only, and are not intended to limit the scope of the invention.

### EXAMPLE 1

In this example, the percent nitrogen oxide conversion was measured in a multi-bed system that included injection of ethanol as a reductant and hydrogen gas (H₂) as a co-reductant in the presence of SO₂. The percent conversion was compared to a single HC—SCR bed system as well as a multi-bed system with ethanol only, with ethanol and SO₂, and inn the single bed system with ethanol, SO₂ and H₂ injection. The multi-bed system included the HC—SCR bed in fluid communication with a NH₃—SCR bed. The HC—SCR bed included a gallium-silver catalyst deposited onto gamma aluminum. The NH₃—SCR was commercially obtained from Cormetech, Inc. The inlet concentration of NOx was 650 ppm, wherein the concentration of reductant (ethanol only) needed to drive the conversion above 75% was determined to be 900 ppm. For these experiments, SO₂ was injected at 10 ppm, and H₂ was at 4,000. In addition to the inlet concentration of NOx at 650 ppm, the exhaust gas consisted of oxygen, gas at 12%, water at 7% and carbon dioxide at 6% with the balance being nitrogen. The results for the various examples and comparative examples are provided in Table 1.

TABLE 1

| | HC—SCR Only | | HC—SCR + NH₃—SCR | |
|---|---|---|---|---|
| NO | NOx | Conversion | NOx | Conversion |
| Conversion (%) | Conversion | to N₂ | Conversion | to N₂ |
| Ethanol only | 82.6 | 69.9 | 87.8 | 84.5 |
| Ethanol + SO₂ | 48.9 | 27.4 | 63.3 | 52.4 |
| Ethanol + | 64.0 | 41.8 | 76.9 | 66.3 |
| SO₂ + H₂ | | | | |
| Ethanol + | — | — | 81.8 | 76.5 |
| H₂ (No SO₂ | | | | |
| added) | | | | |

From Table 1, it is clear that both the combination of a multi-bed system and H₂ injection is needed to minimize the loss of activity observed in the presence of SO₂. The activity of the HC—SCR bed alone dropped by about 50% as the SO₂ was added whereas activity was significantly increased and was almost fully recovered by use of the multi-bed system that included H₂ injection (percent NOx conversion of 76.9, and a percent conversion of NOx to N₂ of 66.3 as compared to 81.8 and 76.5%, respectively, for the multi-bed without added SO₂). While not wanting to be bound by theory, it is believed that the beneficial effect of hydrogen does not come from its ability to activate ethanol for improved reduction of NOx but rather from the fact that H₂ minimizes the deactivation effect attributable to the presence of SO₂.

### EXAMPLE 2

In this example, the effect of sulfur dioxide on the performance of the HC—SCR/NH₃—SCR multi-bed was monitored. The HC—SCR catalyst was formed of gallium and silver as previously described in the example above whereas the NH₃—SCR catalyst was V₂O₅—TiO₂—W₂O₅. The inlet concentration of NOx was 630 ppm, wherein the concentration of reductant (ethanol only) was 900 ppm. In addition to the inlet concentration of NOx, the exhaust gas consisted of oxygen gas at 12%, water at 7% with the balance being nitrogen. For these experiments, SO₂ concentration was varied in the absence of hydrogen gas. Temperature was maintained at 450° C. and SV was at 40,000 hr⁻¹. The results for the varying concentrations of sulfur dioxide are provided in Table 2 below.

TABLE 2

HC—SCR + (V₂O₅—TiO₂—W₂O₅)

| | NOx Conversion | Conversion to N₂ |
|---|---|---|
| SO₂ (ppm) | (%) | (%) |
| 4 | 85 | 76 |
| 8 | 76 | 70 |
| 12 | 72 | 66 |
| 20 | 65 | 58 |

The results clearly show that the percentages of NOx conversion and N₂ conversion directly depended on the amount of sulfur dioxide present in the exhaust fluid, wherein the higher amounts of sulfur dioxide decreased conversion efficiency.

### EXAMPLE 3

In this example, the effect of hydrogen gas (H₂) on the performance of the HC—SCR/NH₃—SCR multi-bed of Example 2 was examined. The exhaust feed was in accordance with that detailed in Example 2 and further included 5 ppm SO₂. The amount of hydrogen injected varied, the results of which are provided in Table 3.

TABLE 3

HC—SCR + (V₂O₅—TiO₂—W₂O₅)

| H₂ (ppm) | NOx Conversion | Conversion to N₂ |
|---|---|---|
| 0 | 68 | 60 |
| 1000 | 83 | 68 |
| 2000 | 85 | 69 |
| 4000 | 92 | 72 |
| 8000 | 95 | 80 |

The results clearly show an increase in NOx conversion and conversion to N₂ as the amount of hydrogen gas was increased as the co-reductant. Moreover, the use of hydrogen gas as a co-reductant in the exhaust fluid minimized sulfur dioxide deactivation of the catalyst materials.

### EXAMPLE 4

In this example, the effect of temperature and ethanol concentration in the presence and absence of the zeolite support was monitored in a single HC—SCR catalyzed bed formed from gallium and silver and the HC—SCR/NH₃—SCR multi-bed of Example 2. The exhaust feed was in accordance with that detailed in Example 2 and further included 4,000 ppm hydrogen gas and 1 ppm of sulfur dioxide. The ethanol to nitrogen oxide ratio was varied as shown in Table 4.

TABLE 4

| | NO to N₂ Conversion | | | | | | | |
|---|---|---|---|---|---|---|---|---|
| | T = 270° C. | | T = 375° C. | | T = 395° C. | | T = 430° C. | |
| | GaAg | | GaAg | | GaAg | | GaAg | |
| EtOH:NO | Only | GaAg + VTiW | only | GaAg + VTiW | only | GaAg + VTiW | only | GaAg + VTiW |
| 1.25 | 25 | 20 | 55 | 61 | 61 | 65 | 69 | 69 |
| 2.25 | 18 | 18 | 49 | 65 | 55 | 70 | 69 | 80 |
| 3.3 | 21 | 15 | 49 | 62 | 54 | 69 | 69 | 79 |

The results show that although conversion efficiencies increased as a function of temperature, the HC—SCR catalyst was still effective at the lower temperatures. Advantageously, the lower amounts of ethanol reductant was observed as providing similar results as the higher amounts of ethanol at the various temperatures.

### EXAMPLE 5

In this example, the effect of temperature and octane concentration in the presence and absence of the zeolite support was monitored in a single HC—SCR catalyzed bed formed from gallium and silver and the HC—SCR/NH₃—SCR multi-bed of Example 2. The exhaust feed was in accordance with that detailed in Example 2 and further included 4,000 ppm hydrogen gas and 1 ppm of sulfur dioxide.

TABLE 5

| | NO to N₂ Conversion | | | | | | | |
|---|---|---|---|---|---|---|---|---|
| | T = 270° C. | | T = 375° C. | | T = 395° C. | | T = 430° C. | |
| | GaAg | | GaAg | | GaAg | | GaAg | |
| Octane:NO | Only | GaAg + VTiW | only | GaAg + VTiW | only | GaAg + VTiW | only | GaAg + VTiW |
| 0.45 | 32 | 26 | 65 | 69 | 66 | 69 | 67 | 68 |
| 0.8 | 22 | 15 | 65 | 71 | 60 | 76 | 70 | 80 |
| 1.125 | 17 | 15 | 50 | 76 | 58 | 71 | 70 | 78 |

As a general observation, octane was more effective than ethanol as a reductant. As in the case of ethanol, the lower amounts of octane provided similar results as the higher amounts of octane over the various temperatures utilized. Moreover, the use of hydrogen gas as a co-reductant in the exhaust fluid minimized sulfur dioxide deactivation of the catalyst materials, which translated to effective conversion at the lower temperatures.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of removing at least nitrogen oxides from an exhaust fluid, the method comprising, in sequence:
providing an exhaust fluid comprising a concentration of nitrogen oxides;
introducing a first reducing agent and a hydrogen gas to the exhaust fluid upstream of a first catalytic bed optimized for hydrocarbon selective catalytic reduction in fluid communication therewith to reduce the concentration of nitrogen oxides in the exhaust fluid, wherein the first reducing agent comprises a hydrocarbon, an alcohol, or a combination comprising at least one of the foregoing; and
further reducing the concentration of nitrogen oxides in a second catalytic bed optimized for ammonia selective catalytic reduction, wherein further reducing the concentration of nitrogen oxides comprises injecting a nitrogen hydride, an ammonia precursor, or a combination thereof into the second catalytic bed.

2. The method of claim 1, wherein the exhaust fluid further comprises sulfur dioxide.

3. The method of claim 1, wherein the first catalytic bed comprises a catalyst material selected from the group consisting of silver, gallium, indium, tin, gold, cobalt, nickel, zinc, copper, platinum, palladium, and oxides and alloys comprising at least one of the foregoing.

4. The method of claim 3, wherein the catalyst material further comprises an inorganic oxide support material selected from the group consisting of alumina, silica, zirconia, titania, and combinations comprising at least one of the foregoing.

5. The method of claim 1, wherein the second catalytic bed comprises a catalyst material selected from the group consisting of indium, copper, silver, zinc, cadmium, cobalt, nickel, iron, molybdenum, tungsten, titanium, vanadium, zirconium, and oxides and alloys comprising at least one of the foregoing.

6. The method of claim 1, wherein the nitrogen hydride is selected from the group consisting of ammonia and hydrazine.

7. The method of claim 1, wherein the first reducing agent comprises an alcohol selected from the group consisting of methanol, ethanol, n-butyl alcohol, 2-butanol, tertiary butyl alcohol, n-propyl alcohol, isopropyl alcohol, and combinations comprising at least one of the foregoing.

8. The method of claim 1, wherein the first reducing agent comprises an aliphatic hydrocarbon.

9. The method of claim 1, further comprising exposing the exhaust fluid stream to a deep oxidation catalyst downstream from the second catalytic bed, and oxidizing carbon monoxide to carbon dioxide.

10. The method of claim 9, wherein the deep oxidation catalyst comprises platinum and aluminum oxide.

11. The method of claim 1, wherein the exhaust fluid comprising a concentration of nitrogen oxides is at a temperature of about 150° C. to about 600° C. and the concentration of nitrogen oxides in the exhaust fluid is reduced by at least 75%.

12. A system of removing at least nitrogen oxides from an exhaust gas, the system comprising:
an exhaust conduit comprising a first catalytic bed optimized for a hydrocarbon selective catalytic reduction process fluidly coupled to a second catalytic bed disposed downstream from the first catalytic bed and optimized for an ammonia selective catalytic reduction process; and
a first reductant fluid source and a hydrogen gas co-reductant source in fluid communication with the exhaust conduit and adapted to be introduced into an exhaust fluid upstream from the first catalytic bed; wherein the first reductant source is selected from the group consisting of a hydrocarbon, an alcohol, or a combination comprising at least one of the foregoing.

13. The system of claim 12, further comprising a deep oxidation catalyst bed optimized for converting carbon monoxide to carbon dioxide, wherein the deep oxidation catalyst is disposed downstream from the second catalytic bed.

14. The system of claim 12, wherein the second catalytic bed comprises an active catalyst material selected from the group consisting of indium, copper, silver, zinc, cadmium, cobalt, nickel, iron, molybdenum, tungsten, titanium, vanadium, zirconium, and oxides and alloys comprising at least one of the foregoing.

15. The system of claim 12, wherein the first catalytic bed comprises a catalyst material selected from the group consisting of silver, gallium, indium, tin, gold, cobalt, nickel, zinc, copper, platinum, palladium, and oxides and alloys comprising at least one of the foregoing.

16. The system of claim 15, wherein the first catalytic bed further comprises an inorganic oxide support material selected from the group consisting of alumina, silica, zirconia, titania, and combinations comprising at least one of the foregoing.

17. The system of claim 12, wherein the first reductant fluid source comprises an alcohol selected from the group consisting of methanol, ethanol, n-butyl alcohol, 2-butanol, tertiary butyl alcohol, n-propyl alcohol, isopropyl alcohol, and combinations comprising at least one of the foregoing.

18. The system of claim 13, wherein the deep oxidation catalyst comprises platinum and aluminum oxide.

19. The system of claim 12, wherein the ammonia selective catalytic reduction process comprises a nitrogen reductant source selected from the group consisting of nitrogen hydrides, an ammonia precursors, and combinations of the foregoing.

20. The system of claim 12, wherein the first catalytic bed comprises gallium and silver.
